(19) United States
(12) Patent Application Publication
(10) Pub. No.: US 2011/0271190 A1
(43) Pub. Date: Nov. 3, 2011

(54) FIGHT ENGINE

(76) Inventor: RON KORT, Irvine, CA (US)

(21) Appl. No.: 12/723,671

(22) Filed: Mar. 14, 2010

Related U.S. Application Data
(60) Provisional application No. 61/210,077, filed on Mar. 16, 2009.

(51) Int. Cl. G06F 3/048; G06F 15/16

(52) U.S. Cl. 715/719; 709/219

(57) ABSTRACT

System and Method for uploading, managing, incorporating user feedback and user expressed preferences, computing and assigning rating and match-ups, and delivering digital video content, including streaming video, related to competitive Mixed Martial Arts (MMA) matches. All users who are logged into a database as members have varying degrees of access and authority to up-load, access, view, rate, comment on, match-up, track and obtain information on video content and information related to individual competitors, events, and other reference information related to MMA. The system allows user content to be uploaded, categorized, sorted, data-based, and available for search, comment, rating, and interactive video title selection and presentation.

### FIELD OF THE INVENTION

The present invention describes a method and system for uploading, managing, interactively choosing a selection from a database and delivering video content, including streaming media and database and user selections and for facilitating access to the video content to many subscribers as they become registered users. The system according to one embodiment allows receipt of video content from a user, assigns a user identifier (UID) and offered video selection title, and adds it to the content pending validation and stores the content. The client/user is given a playlist uniform resource locator (URL) for where it is published on the graphic web user interface, the URL includes the stream ID. A preferred embodiment for a video-on-demand environment uses a cursor to represent a selector tool to choose video content on the database, which is displayed on a user's screen at the user's location. Activation of the URL by an end user causes the stream to be served to the end user, without the user receiving or providing any indication of the specifics of where the content was stored. An embodiment provides a system and method that permit clients to actively manage their content, including defining logical folders and subfolders containing item(s) of the content and defining logical stream groups, containing items of the content. The method includes receiving from the users or subscribers comments where each comment contains information relating to the content or to any of the subject characters of the video content. The method determines if the comments are approved by applying a template to the comments and also receives comment requests from the users or subscribers. The video content is uploaded, managed, viewed, commented on, and arranged via the Internet and allows client/users to up-load, manage, and deliver streaming media content. The client/users are provided a graphical web interface for access to the server(s), and for interactively accessing the server(s) for media selections including movies, videos and graphical offerings.

### BACKGROUND

Mixed Martial Arts, or MMA, is a popular form of hand-to-hand combat, including armed and unarmed, and examples of competitive forms and styles used in MMA include boxing, kickboxing, as well as all the traditional and non-traditional forms of martial arts and other methods and means of competitive combat. The explosive growth of the sport of Mixed Martial Arts as a method of amateur and professional competition as well as the now fully integrated manner in which the internet and interactive communication platforms based on the internet, including Social Media, has created an environment that is changing the way the average individual and the MMA competitor interact and effect each other. As the Internet becomes increasingly accessible around the world and MMA gains acceptance and popularity globally as well, consumers need efficient internet tools to navigate the vast information and development of individual MMA competitors as well as the overall sport and landscape of MMA in general.

Internet portals now provide consumers an access and guide into the vast extent of information and history of individual MMA competitors as well as how the various match-ups and competitor personal information, such as diet, training, psychological or emotional well-being, etc., affect the future performance as compared to another MMA competitor. The information available on the Internet, such as a range of search, email, news, shopping, chat, maps, finance, entertainment, and other content and services, offer consumers an incredible array of information upon which to base future projections of win, loss, and tie when pitting one MMA competitor against another, especially when video competitions are available for access and feedback, comment, and rank allows for interactive selection and presentation of competitor match-ups.

Consumers will now be able to input ranges of a continuous or ordinal variables, such as, for example, data ranges related to weight, win-loss record, age, height, average time to win, average time to loss, average time between bouts, etc. These data ranges will provide an interactive visualization of the dataset selected by the user-entered data ranges and show the relationship of the selection to the probability and demand for a specific competitor to competitor match-up. Thus, what results is a system and method to facilitate interactive selection of non-discrete competitor and match-up demand data ranges and presentation of dataset results for the consumers and competitors.

As television and other video-based media move from the current pre-programmed regime to a video-on-demand regime, conventional methods for program selection like printed television guides, pay-per-view telephone selection, television programming grids and hierarchies of menus are becoming obsolete. Available video titles stored in a database are likely to be constantly changing as new offerings are added and old offerings are deleted. This constant turnover makes it difficult and expensive to inform users of the current offerings, for example, by providing every subscriber with an updated, printed list of video selections at regular intervals.

Similarly, it is impractical to list a large number of available titles on the screen and ask the subscriber to make a selection for viewing due to the difficulty of finding particular competitor videos or match-ups in such a list. In addition, such an extensive listing makes it impossible, as a practical matter, to provide background information on the competitors and provide a basis for providing feedback for suggestions and requests for future match-ups.

Presently employed interfaces for video offerings use pre-programmed materials in the sense that they list all video offerings available from a server and do not adjust the selection offering according to user's upload, history of use, and viewing habits. A conventional way of providing interactive access to information is by a sequence of menus and submenus. Media selections, including movies, video and graphical offerings, can be organized by categories and be accessible using a new graphical web interface (the ‘Fight Engine’) for searching a database of media selections so as to advise users of available selections in a rapid, iconic, intuitive and easily accessible manner within the sequence of menus.

### SUMMARY OF THE INVENTION

The present invention provides an intuitive and easy-to-use web site with a graphical web user interface for searching a server database for video content and related registered user information and data. The resulting preferred embodiment provides a video-on-demand system for interactively choosing a video from the server(s) as well as information, statistics and comments related to that video and characters featured in said video.

The present invention solves the needs of consumers of MMA to be able to upload, manage search deliver and view streaming media and other video content. The system according to one embodiment receives video content from the client, assigns a user identifier (UID) and validated title to the video content and stores the content, including any comments, also requiring validation, related thereto.

Another embodiment of the present invention permits registered users and subscribers to actively manage their video content, including defining logical folders and subfolders in a 3D virtual space containing item(s) of content; defining logical stream groups.

The advantages of being a member of the Fight Engine website and registered user populace are that a mixed martial arts promoter from one part of the world can go online to the Fight Engine, research members and registered users and negotiate a heavyweight match between two registered fighters who have their videos and key information available on the server(s)—thereby posted on the Fight Engine website.

Fight Engine changes the way mixed-martial-arts fighters—from professionals, amateurs and even neighborhood tough guys—market themselves and develop fan bases. Simply by being registered members of www.fightengine.com, fighters are able to land paying bouts, whereas competition audience members of the www.fightengine.com website will include promoters, managers, sponsors, other fighters, and most of all—the fans.

Registered fighters from around the world do not have to be well-known or experienced. Unknown or even novice fighters may be discovered by posting his or her video and can also challenge other registered fighters, allowing each participant to accept or deny challenges, as well as express semi-uncensored opinions about any posted challenges.

MMA fighters from around the world, even those under contract and prohibited from participating in various ‘fight cards’ or jurisdictions can still use the website as a free market in the virtual video arena where information on potential opponents is available and building loyal fan bases is possible.

Posting action videos allows a single point of collection of videos and search ability within the specific video arena of MMA. Registered fighters and other members can gauge the popularity of any fighter through the website and its fan feedback.

Promoters and managers can scout talent and fans can become true matchmakers, publicly criticizing video-posted fighters as well as arguing with other fans regarding which fighters they want matched up in a future bout.

The website is non-discriminatory and allows both male and female fighters, as well as ‘ring girls.’

A thermometer can be found on the right-hand side of the website, which illuminates on a rising basis, according to the number of registered fighters and, subsequently, fights will be arranged when the thermometer reaches its full apex.

The “KO the Pro” section is where top-level fighters post action videos as other fighters battle for selection in a “KO the Pro” match-up. The first “KO the Pro” features the legendary Bob “The Beast” Sapp. Other “KO the Pro” members include the famous Kimo Leopoldo, Jeff “Snowman” Monson, Jimmy Ambriz, David “Tank” Abbott, former UFC heavyweight champion Ricco “Suave” Rodriguez, and former UFC heavyweight contender Wes Sims.

FightEngine.com is a state of the art interactive website that features legendary superstars and MMA fighters like Bob Sapp and other headline fighters on its board of advisors, in order to revolutionize the way mixed-martial-arts fighters market themselves, promoters and managers scout for fighters, and allow fans to become legitimate matchmakers.

This is an opportunity for the neighborhood tough guy or the licensed professional to get an equal amount of exposure.

FightEngine.com allows fighters from any country to register, gain invaluable exposure and be scouted by top MMA promoters. FightEngine.com enables MMA organizations to scout fighters from around the world without leaving their computer in order to discover the next great MMA fighter.

FightEngine.com is apolitical without any preference to any promoters. Promoters and fighters can gain international notoriety for themselves through the www.fightengine.com website. Any registered fighter, for a nominal fee, may challenge other registered fighters, allowing each participant to accept or deny challenges, as well as express their semi-uncensored opinions about any posted challenges.

Fans can get in on the action, simply by registering to become quasi-matchmakers, picking fighters they'd like to watch in matches, in addition to commenting about fights other spectators propose as well as individual competitor videos.

A thermometer can be found on the right-hand side of the website, which will illuminate on a rising basis, according to the amount of registered fighters, and fights will be arranged once the thermometer reaches the apex.

FightEngine.com serves as a tool to arrange fights for those selected fighters chosen by an accumulation of votes from the FightEngine.com website.

### BRIEF DESCRIPTION OF THE DRAWINGS

Having thus described the invention in general terms, reference will now be made to the accompanying drawings, which are not necessarily drawn to scale, and wherein:

FIG. 1 shows schematically the web page hierarchy of the Fight Engine web site according to one embodiment of the present invention;

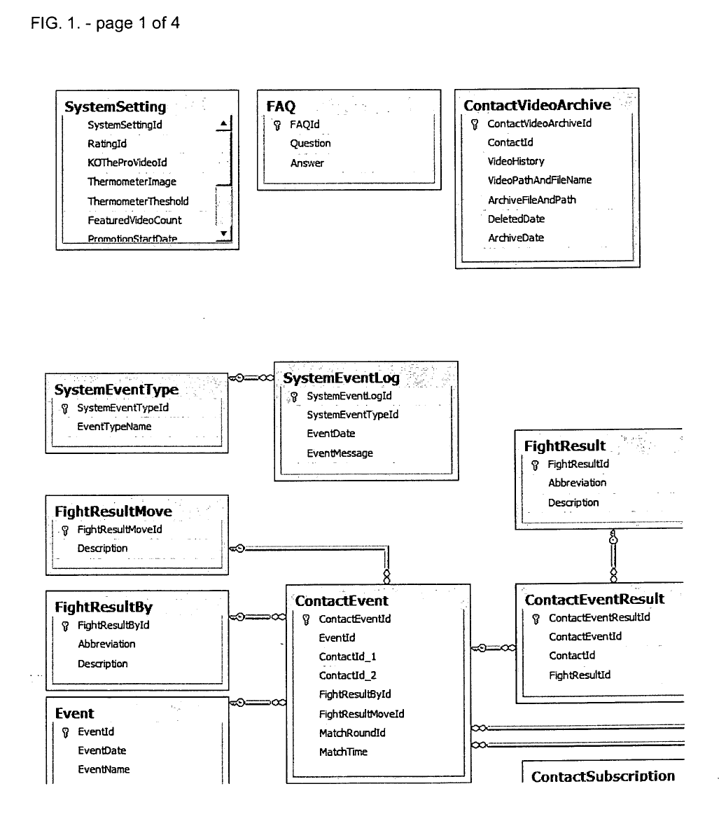

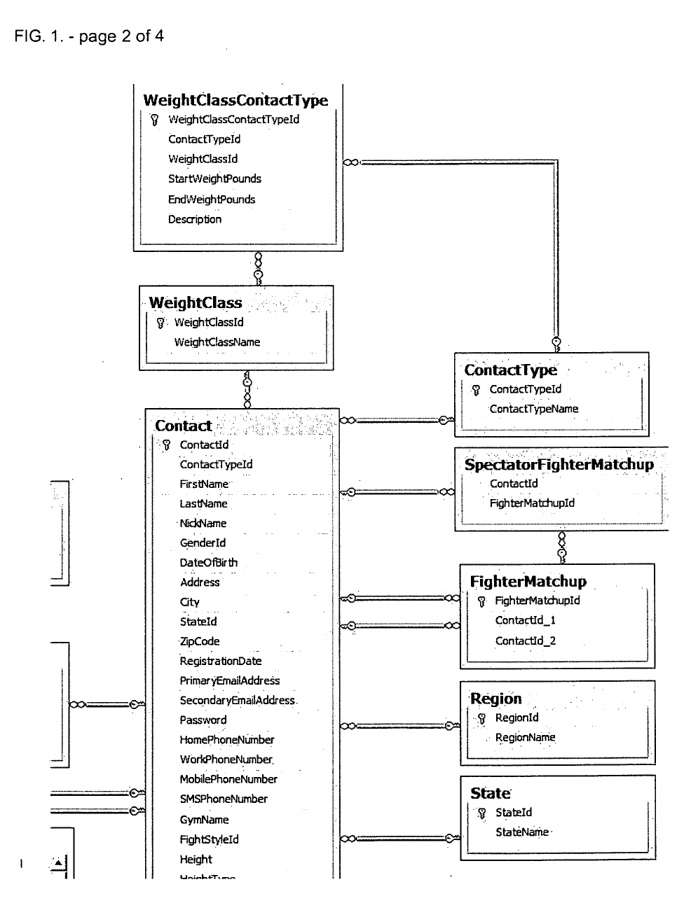

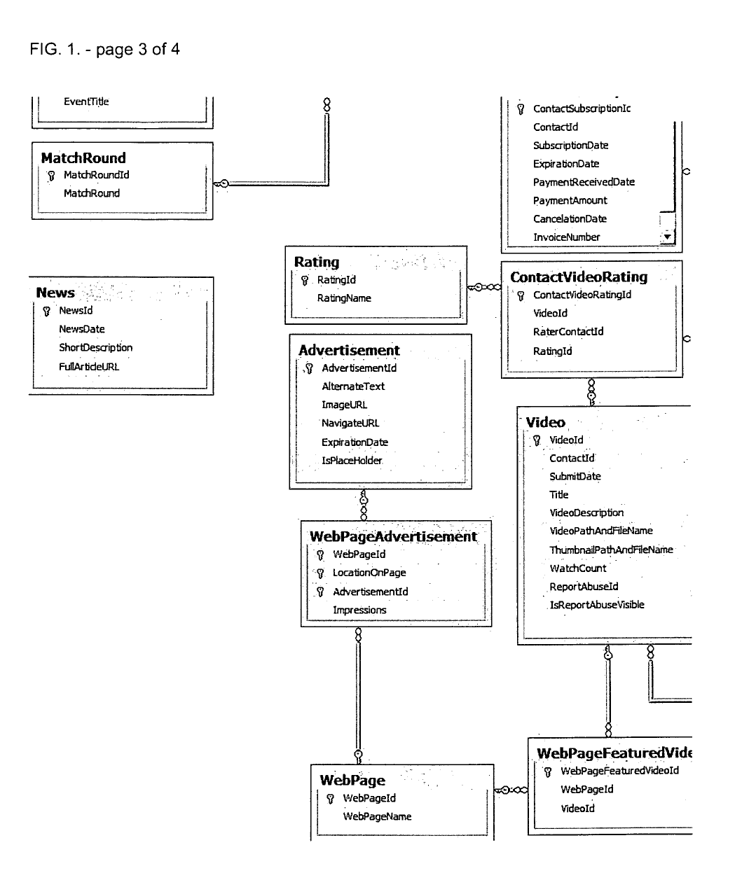

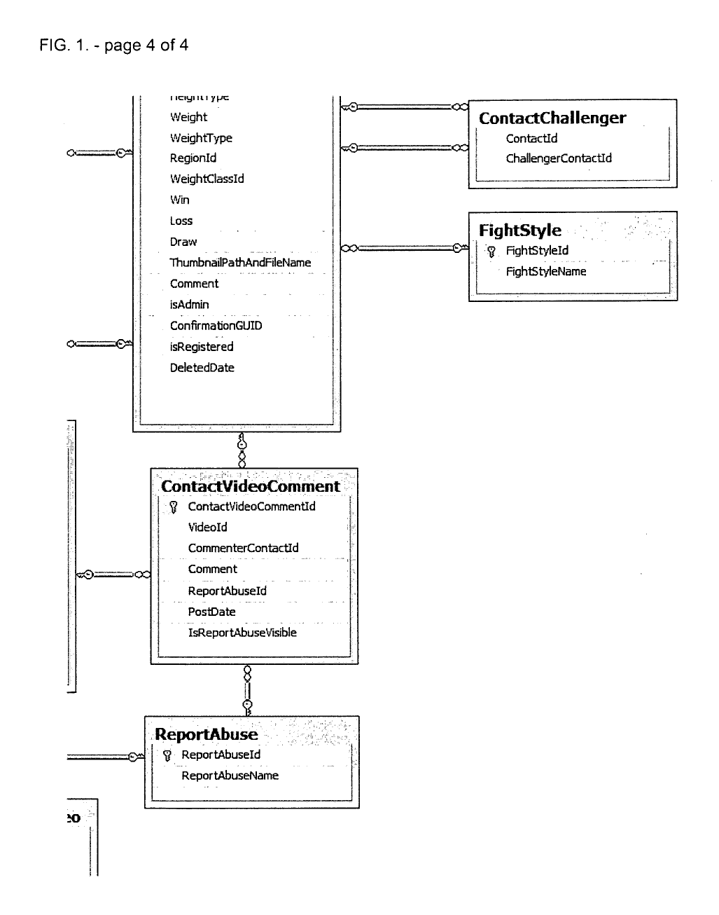

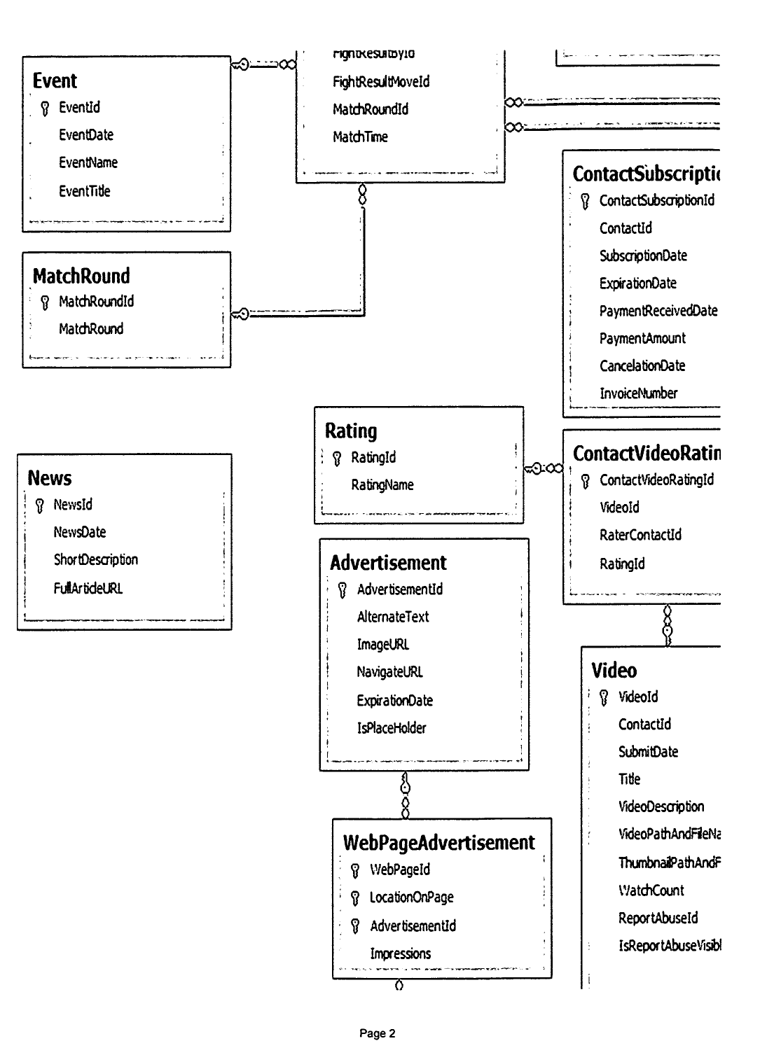

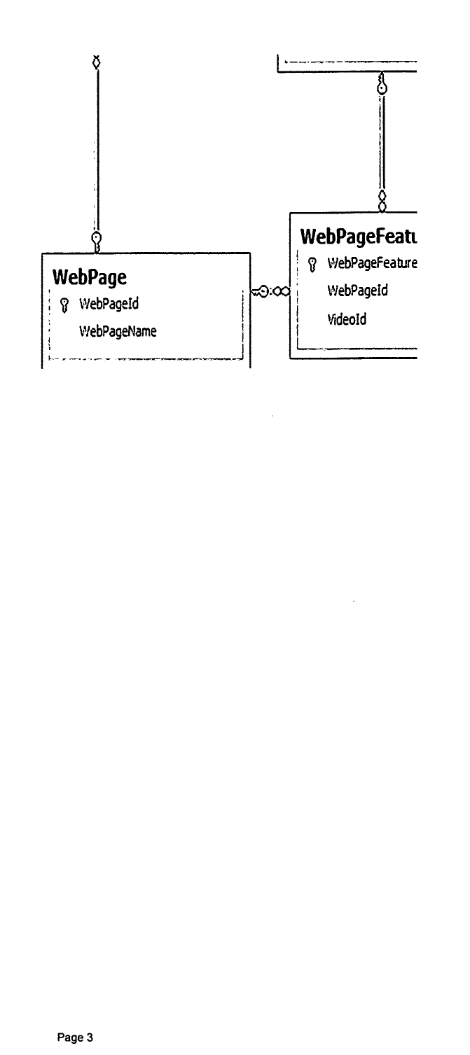

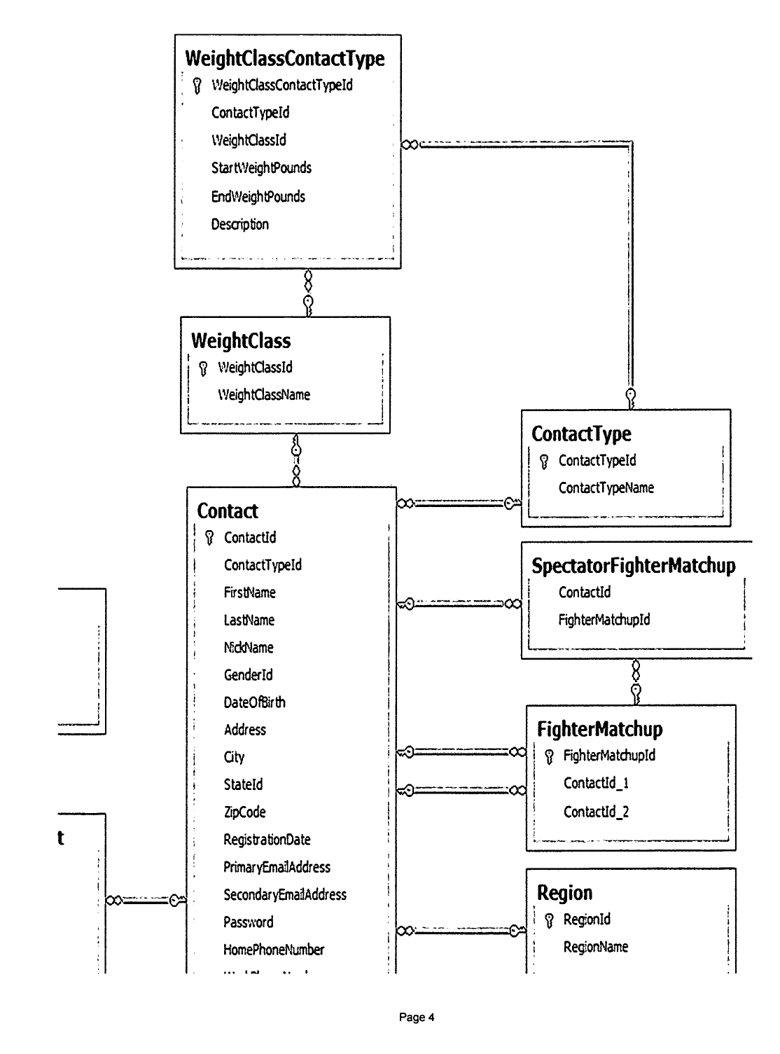

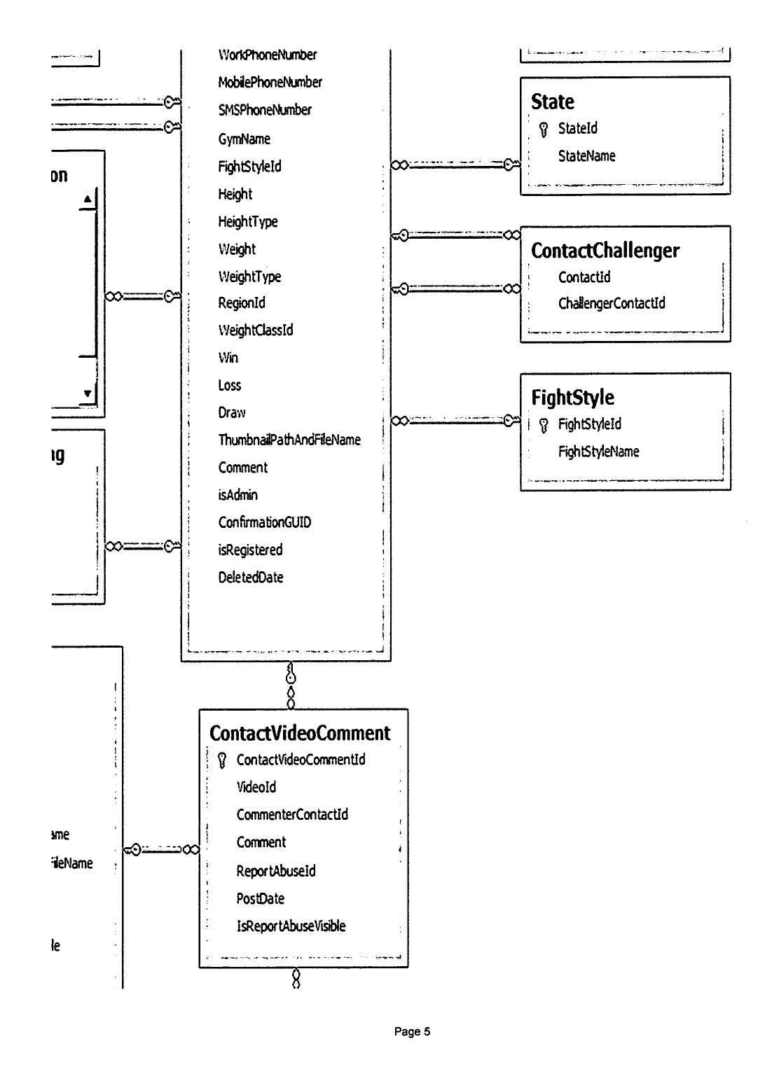

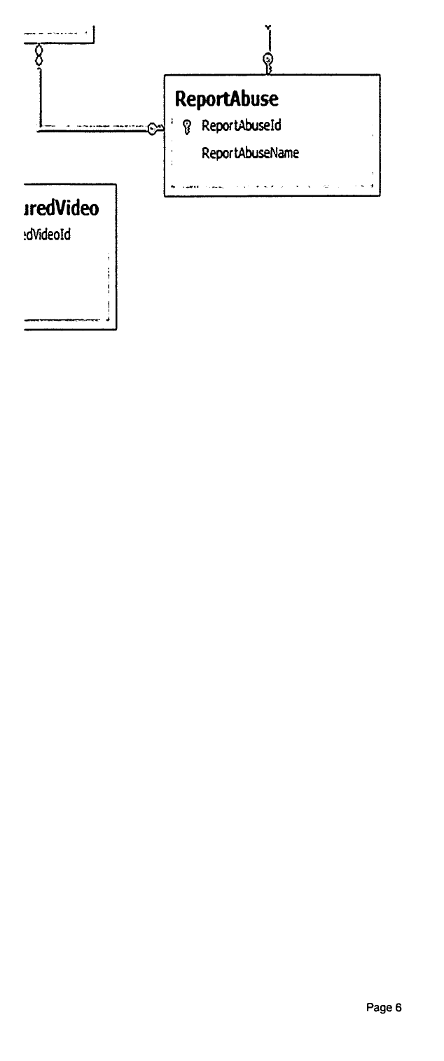

### DETAILED DESCRIPTION OF THE INVENTION

### Home Page

1. Most watched videos by Selection Category—male fighter, female fighter, and ring girls
   (a) Database tracks each view
2. Most voted on videos by Selection Category—male fighter, female fighter, and ring girls
   (a) Database tracks each vote (does not allow a user to vote more than once per video selection, but does allow users to change their vote at a later time)
3. Featured videos
   (a) Randomly selected videos from the database, providing exposure to all uploaded content

### Male Fighters Page

1. Most watched videos by weight class—middle weight, heavy weight, super heavy weight
   (a) Database tracks each view
2. Most voted on videos by weight class—middle weight, heavy weight, super heavy weight
   (a) Database tracks each vote (does not allow a user to vote more than once per video selection, but does allow users to change their vote at a later time)
3. Featured videos
   (a) Randomly selected videos from the database, providing exposure to all uploaded content

### Female Fighters Page

1. Most watched videos by weight class—middle weight, heavy weight, super heavy weight
   (a) Database tracks each view
2. Most voted on videos by weight class—middle weight, heavy weight, super heavy weight
   (a) Database tracks each vote (does not allow a user to vote more than once per video selection, but does allow users to change their vote at a later time)
3. Featured videos
   (a) Randomly selected videos from the database, providing exposure to all uploaded content

### Ring Girls Page

1. Most watched videos—display 4×3 for a total of 12
   (a) Database tracks each view
2. Most voted on videos—display 4×3 for a total of 12
   (a) Database tracks each vote (does not allow a user to vote more than once per video selection, but does allow users to change their vote at a later time)
3. Featured videos
   (a) Randomly selected videos from the database, providing exposure to all uploaded content

### Play Video Page

When NOT logged in:
1. Gives details about video
   (a) Includes fighter info and statistics
   (b) Ratings
   (c) Watch count
2. Watch video
   (a) Has ability to expand to full screen
3. Display code to allow the video to be embedded to another site
4. Additional video
   (a) More videos from the fighter being watched
   (b) Display fighters who have been challenged by the fighter being watched
   (c) Display fighters who have challenged the fighter being watched
   (d) Display the spectators choice of challenges for the fighter being watched
5. Comments
   (a) Are displayed about the video being watched
   (b) Are displayed about the fighter being watched (comprehensive across all videos owned by the fighter in question)
      Additional Features when Logged in:
1. Rate videos
2. If the user is a fighter, challenge other fighters of the same gender
3. Match up fighters
4. Post comments about a specific video selection

### Manage Account Page

1. Manage personal information
2. Manage login and password
3. Manage videos
   (a) Upload videos, after which:
      it is processed and standardized to one size for server storage
      converted to flash
      www.fightengine.com watermark is embedded into the video and re-encoded
      thumbnail extract available for preview
      files are stored on file system and references are stored in database
   (b) edit video title and description
   (c) delete videos
4. subscriptions
   (a) processed through PayPal and automatically reconciled to fightengine.com system

1. A method comprising of receiving, by an ingest server, video content from a registered and approved user (client); storing, by a repository server, said video content, the video content having an associated server hostname and a filename; assigning a unique identifier to the video content, and associating the unique identifier, server hostname and filename; providing the client with a link containing the unique identifier but not the server hostname and filename associated with the video content's unique identifier; receiving, by a playlist server, a request for the content, the request based on activation of the link, the request including the unique identifier but not the server hostname and filename associated with the video content's unique identifier; determining, by the playlist server, the server hostname and filename based on the unique identifier received with the request; creating, by the playlist server, a redirector file, the redirector file including the server hostname and filename associated with the video content's unique identifier, the redirector file is returned in response to the request.

2. The method of claim 1, wherein the unique identifier is a stream identifier.

3. The method of claim 1, wherein the unique identifier is the name of the video content as provided by the client and approved via a Video Name Validation Process.

4. The method of claim 1, wherein the video content is a streaming media file.

5. The method of claim 1, wherein the video content is added to any existing playlist for that client comprising multiple streaming media files.

6. The method of claim 1 wherein the link specifies a program for determining the hostname and filename based on the unique identifier.

7. A method of providing an end user access to video content, the method comprising: causing video content to be stored, by a repository server, and a unique identifier to be assigned to the video content, the video content having a server hostname and a filename when stored, the unique identifier of the video content being associated with the video content's server hostname and filename; receiving, by an ingest server, the unique identifier to the video content but not the server hostname and filename associated with the video content's unique identifier; publishing a link for activation by the end user, the link including the unique identifier of the video content but not the server hostname and filename associated with the video content's unique identifier, wherein activation of the link causes resolution of the unique identifier into the server hostname and the filename of the video content, and causes the video content to be provided to the end user, by a playlist server, based on the server hostname and filename of the video content determined using the unique identifier.

8. The method of claim 7, wherein the unique identifier is a stream identifier.

9. The method of claim 7, wherein the unique identifier is the validated name of the video content.

10. The method of claim 7, wherein the video content is a streaming media file.

11. The method of claim 7, wherein the video content provides a link to a playlist comprising multiple streaming media files related to video content with the validated name.

12. A method of interactively accessing a database of selections, each such selection being classifiable into at least two categories, such selections being stored in at least one computer-accessible storage, comprising the steps of: representing at least a portion of the database with a geometric object corresponding to a virtual space having logical coordinates in at least two dimensions, wherein each selection is assigned to a point on the logical coordinates in accordance with its categories; and displaying on a monitor pictorial icons representing the video contest with the validated name stored in the database in accordance with the logical coordinates of the selected video content.

13. The method of claim 12, further comprising displaying a navigator icon for identifying a location in the virtual space of the selections represented by pictorial icons.

14. The method of claim 12, wherein the geometric object is a three-dimensional structure, to allow for more than one selection to be located in the same 2D coordinates area such that the quantity of video selections available in a single 2D coordinate represents the third dimension in the geometric object based database.

15. The method of claim 12, further comprising entering user input.

16. The method of claim 12, wherein the selections are displayed such that a pictorial icon selected by a user is distinguished in appearance from the other pictorial icons.

17. The method of claim 12, wherein the selections include videos that do not fall within the two categories of classifiable selections.

18. The method of claim 12, further comprising displaying a subset of selections according to the registered user's preference.

19. The method of claim 12, wherein the monitor is a television or other viewing screen, including an LCD monitor or flat-screen.

20. A method of interactively accessing a remotely located database of selections, each such selection being classifiable into at least two categories, such selections being stored in at least one computer-accessible storage, comprising the steps of: establishing a communication between a registered user and the remotely located database on its server(s); representing at least a portion of the database with a geometric object corresponding to a virtual space having logical coordinates, wherein each selection is assigned to a 2D point on the logical coordinates in accordance with its categories; and displaying icons representing at least some of the selections stored in the database in accordance with the logical coordinates of the selections.

21. The method of claim 20, wherein the selections include videos that do not fall within the two categories of classifiable selections.

22. The method of claim 20, wherein the user and the remotely located database are connected to a computer network.

23. The method of claim 20, wherein the computer network is the World Wide Web.

24. A system for interactively accessing a selection from a database of selections, comprising: database server(s) for storing and for searching and retrieving a video selection from the database server(s); a controller for accepting input from a registered user; and a user graphic web user interface for interacting with the data stored on the server(s) by generating signals for icons as arranged on a geometric object representing a virtual space having logical coordinates in at least two dimensions, where each selection is assigned to a point on the logical coordinates in accordance with its classifications.

25. The system of claim 24, including a graphic web user interface for registered users to enter information and upload video content as well as navigate self content and information as well as those public-facing portions available for other registered users.

26. The system of claim 24, including a switching means through which the registered user communicates with the server(s).

27. The system of claim 24, where the graphic web user interface includes navigator icons to identify a location in the virtual space corresponding to the content represented by the appropriate icon.

28. The system of claim 24, where the graphic web user interface further includes an animation sequence of the icons according to the registered user's preferences.

29. The system of claim 24, where the graphic web user interface includes the virtual space as a multi-dimensional structure having at least two dimensions with a third dimension for video content in the same selection category in the 2D coordinate space.

30. The system of claim 24, wherein the graphic web user interface includes icons arrayed by title along the 2D coordinate space.

31. The system of claim 24, wherein the graphic web user interface generates icons for selections in the virtual space for video selections uploaded for male or female MMA competitors as a registered user makes a transition from one video selection to another.

32. The system of claim 24, wherein the graphic web user interface includes icons arrayed such that categories of selections can be found in chronological order within each category.

33. The system of claim 32, where the graphic web user interface generates icons for selections in the virtual space such that selections from the same 2D coordinates are displayed as a registered user makes a transition from one subject category to another.

34. The system of claim 24, wherein the graphic web user interface allows the registered user to enter comments on each video selection so that the comment is ‘tagged’ and tied to the video selection pending completing a validation process that is similar to the validation process for titles and naming.

35. A system for interactively accessing a digital video selection from a remotely located database by a user, comprising: database server(s) for storing, searching and retrieving selections from the database; a controller for processing information from a registered user; and a graphic web user interface connecting the server(s) and the registered user's entry point via the world wide web through the graphic web user interface for traversing the two dimensional coordinates, where each selection is assigned to a point on the logical coordinates in accordance with its classifications.

36. The system of claim 35, including switching for the controller to communicate with the server(s).

37. The system of claim 35, wherein the graphic web user interface includes a means for generating comments and attaching them to a specific video selection.

38. A system that includes Site Stats, Counts by Registration Type, Repeater Counts By Type, Video Count By Fighter, ranking counter, Watch Count, Repeater Fighter Ratings, Total Rating Count, and Total Watch Count.

39. A system that manages advertisements based on the type of files selected and content of comments provided, up to a maximum of 10 files.

40. A system that uses images of a thermometer with a ‘mercury’ level that can increase based on the number of user/subscribers and their votes for a specific video selection, and a thermometer threshold.
